(19) United States
(12) Patent Application Publication
(10) Pub. No.: US 2017/0280170 A1
(43) Pub. Date: Sep. 28, 2017

(54) CONTENT DISTRIBUTION CONTROL APPARATUS AND CONTENT DISTRIBUTION CONTROL METHOD

(71) Applicant: FUJITSU LIMITED, Kawasaki-shi (JP)

(72) Inventors: Naoya HONGO, Kawasaki (JP); Takeshi OHTANI, Kawasaki (JP); Jun KAKUTA, Kawasaki (JP)

(73) Assignee: FUJITSU LIMITED, Kawasaki-shi` (JP)

(21) Appl. No.: 15/467,154

(22) Filed: Mar. 23, 2017

(30) Foreign Application Priority Data
Mar. 23, 2016 (JP) 2016-058200

(51) Int. Cl. H04N 21/2343; H04N 21/414; H04N 21/24

(52) U.S. Cl. CPC H04N 21/2343; H04N 21/2407; H04N 21/41407

(57) ABSTRACT

An apparatus and a method for controlling content distribution control method for controlling distribution to a plurality of distribution destinations of content that is reproducible at different reproduction positions, The apparatus groups the plurality of distribution destinations based on a reproduction position of the content and information indicating a predetermined time period from the reproduction position that is obtained from each of the plurality of distribution destinations, and determines a distribution method for distributing content to a group that is formed by the grouping, based on a usage status of a network that is used to distribute the content to the plurality of distribution destinations.

### CROSS-REFERENCE TO RELATED APPLICATION

This application is based upon and claims the benefit of priority of the prior Japanese Application No. 2016-058200 filed on Mar. 23, 2016, the entire contents of which are incorporated herein by reference.

### FIELD

The present invention relates to a content distribution control apparatus, a content distribution control method, and a non-transitory computer-readable recording medium.

### BACKGROUND

In recent years, terminals equipped with a wireless LAN (local area network) interface are in widespread use. Such terminals include, for example, laptop PCs (personal computers), smartphones and tablet PCs.

Further, the use of a content distribution service referred to as a “second screen” has been spreading in recent years. According to the second screen service, image or video content (for example, moving image highlights or a moving image replay of a sports match) that were photographed with a camera are distributed to a user (spectator) possessing a terminal by using wireless LAN equipment installed in a sports stadium or the like. For example, in a baseball or basketball stadium, detailed information regarding a match or moving image replays or the like are distributed to a smartphone that a user possesses.

For further information, see Japanese Laid-Open Patent Publication No. 2011-176730, Japanese Laid-Open Patent Publication No. 2013-110477, Japanese Laid-Open Patent Publication No. 2008-165479, and Japanese Laid-Open Patent Publication No. 2010-187083.

### SUMMARY

One of aspects is a content distribution control apparatus. The content distribution control apparatus includes a grouping unit that performs grouping of a plurality of distribution destinations of content that is reproducible at a different reproduction position at each distribution destination, based on a reproduction position of the content and information indicating a predetermined time period from the reproduction position that is obtained from each of the plurality of distribution destinations; and a determination unit that, based on a usage status of a network that is used to distribute the content to the plurality of distribution destinations, determines a distribution method for distributing content to a group that is formed by the grouping.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 schematically illustrates a configuration example of a content distribution system;

FIG. 2 is a view that illustrates an example of the hardware configuration of a gateway and a terminal;

FIG. 3 illustrates an example of the configuration of a gateway and a terminal;

FIG. 4 illustrates an example of the data structure of a content buffer management table;

FIG. 5 illustrates an example of the data structure of an application execution status management table;

FIG. 6 illustrates an example of the data structure of a content distribution status management table;

FIG. 7 is a flowchart illustrating an example of processing 1 (processing that provides a fragment of content to an application);

FIG. 8A is a flowchart illustrating an example of processing 2 (processing that distributes a fragment of content that an application requests to a terminal), and illustrates processing that is performed at a gateway;

FIG. 8B is a flowchart illustrating an example of processing 2 (processing that distributes a fragment of content that an application requests to a terminal), and illustrates processing reduction of a bandwidth at a terminal;

FIG. 9 is a flowchart illustrating an example of processing for grouping terminals;

FIG. 10 is an explanatory drawing for explaining the basic concept of grouping;

FIG. 11 is an explanatory drawing for explaining an example of grouping;

FIG. 12 is a configuration example of a gateway and a terminal according to a second embodiment;

FIG. 13 illustrates a data structure example of an application execution status management table 309B in the second embodiment;

FIG. 14 is an explanatory drawing of a method for grouping terminals 5 in the second embodiment;

FIG. 15A is a flowchart illustrating an example of processing for grouping terminals in the second embodiment;

FIG. 15B is a flowchart illustrating an example of processing for grouping terminals in the second embodiment;

FIG. 16 is an explanatory drawing of a grouping method in the second embodiment;

FIG. 17 is a flowchart illustrating an example of “processing 1” in the second embodiment;

FIG. 18A is a flowchart illustrating an example of “processing 2” in the second embodiment; and

FIG. 18B is a flowchart illustrating an example of “processing 2” in the second embodiment.

### DETAILED DESCRIPTION OF EMBODIMENT

Hereinafter, embodiments of the content distribution control apparatus, the content distribution control method and the program are described with reference to the accompanying drawings. The configurations of the following embodiments are for the purpose of exemplification, and the present invention is not limited to the configurations described in the embodiments.

In the case of content that is distributed by a content distribution service, for example, a reproduction start timing and a reproduction position of a moving image to be reproduced by terminals differ between the respective terminals. On the other hand, in an environment in which a sports match is being played at a stadium, in many cases, at a specific timing such as immediately after a point is scored or immediately after the start of a rest period, users start to acquire content at the same time within a fixed time period. Congestion is liable to occur when users access a wireless network at the same time in this manner. If content distribution to a terminal is delayed due to congestion and reproduction of a moving image is interrupted or the like, a problem arises that the user's quality of experience (QoE) which the user subjectively perceives and recognizes decreases.

An object of the embodiments of the present invention is to provide a content distribution control apparatus, a content distribution control method thereof and a program that can enable a reduction in a bandwidth that is used for content distribution with respect to the distribution of content that is reproducible at a different reproduction position at each distribution destination.

### First Embodiment

<System Configuration>

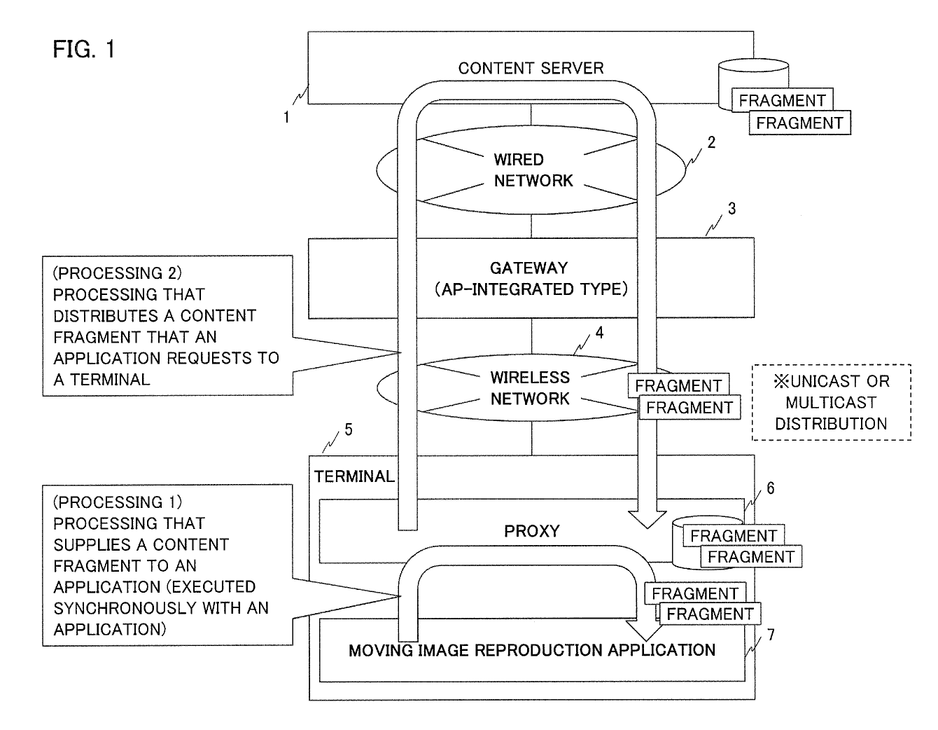

FIG. 1 schematically illustrates an example of the configuration of a content distribution system. In FIG. 1, a content distribution system includes a content server 1, a gateway 3 that is connected with the content server 1 through a wired network 2, and a plurality of terminals 5 that are connected with the gateway 3 through a wireless network 4. However, in FIG. 1, one terminal 5 is illustrated as an example. Each terminal 5 includes a proxy server (proxy) 6 and a moving image reproduction application 7. The gateway 3 is an example of a “content distribution control apparatus”. The plurality of terminals 5 are an example of a “plurality of distribution destinations”. The wireless network 4 is an example of a “network used for distribution of content”.

In the first embodiment, to simplify the description, the gateway 3 is exemplified in which an access point (AP) of a wireless LAN and a gateway device are integrated. However, the system can also adopt a configuration in which, instead of the integrated gateway 3, the gateway and the AP are separated. At this time, a configuration can also be adopted in which a plurality of APs are connected to a single gateway. For example, in a case where a single gateway and a plurality of APs are applied, the terminal 5 communicates with the gateway device via any of the plurality of APs. The gateway performs processing in AP units as described later. In a case where a configuration is adopted in which the gateway and the AP are separates, a BSSID (basic service set identifier: MAC (media access control) address of the AP) of the AP to which the terminal 5 is connected is transmitted from the terminal 5 to the gateway. The BSSID (identifier of the AP) is used to link the terminal 5 and the AP at the gateway.

In the first embodiment, a moving image distribution service is described as one example of the content distribution service. The content includes moving images (video) and audio. The moving image distribution service divides moving image content into a plurality of minute fragments. The fragments are distributed to the terminal 5 through the gateway 3. The terminal 5 receives the fragments in reproduction order and performs reproduction processing. For example, HLS (Http Live Streaming) and MPEG-DASH (Dynamic Adaptive Streaming over HTTP) may be mentioned as moving image distribution mechanisms that realize the moving image distribution service. However, moving image distribution mechanisms other than these mechanisms can also be applied.

In a moving image distribution service such as HLS or MPEG-DASH, a URL (uniform resource locator) of each fragment of moving image content as well as a reproduction order and reproduction options for the fragments are previously defined in a file called a “playlist”.

The moving image reproduction application 7 acquires the playlist and, in accordance with the reproduction order defined in the playlist, acquires fragments that were received by the proxy 6 and reproduces a moving image. At this time, as long as a situation continues in which a next fragment is obtained while the moving image is being reproduced using a certain fragment, reproduction of the moving image is performed without any delays (is performed continuously). That is, in a case where the next fragment is distributed within a predetermined time period from the reproduction position of the content, the distribution destination can continue reproduction of the content without any interruption or stoppage.

The processing according to the first embodiment can be generally divided into the following processing 1 and processing 2. The processing 1 is processing that provides fragments of moving image content to the moving image reproduction application 7. The processing 2 is processing that distributes fragments of moving image content which the moving image reproduction application 7 requested (required) to the terminal 5.

The processing 1 is synchronously executed by the proxy 6 in response to a request by the moving image reproduction application 7 to acquire a fragment. The processing 2 is processing that arises based on a request from the moving image reproduction application 7 as a trigger, and is performed asynchronously with respect to the processing 1. In the processing 1, the proxy 6 waits for distribution of a fragment to the terminal 5 by the processing 2, and provides a fragment that is in accordance with a request to the moving image reproduction application 7.

<Configuration of Terminal and Gateway>

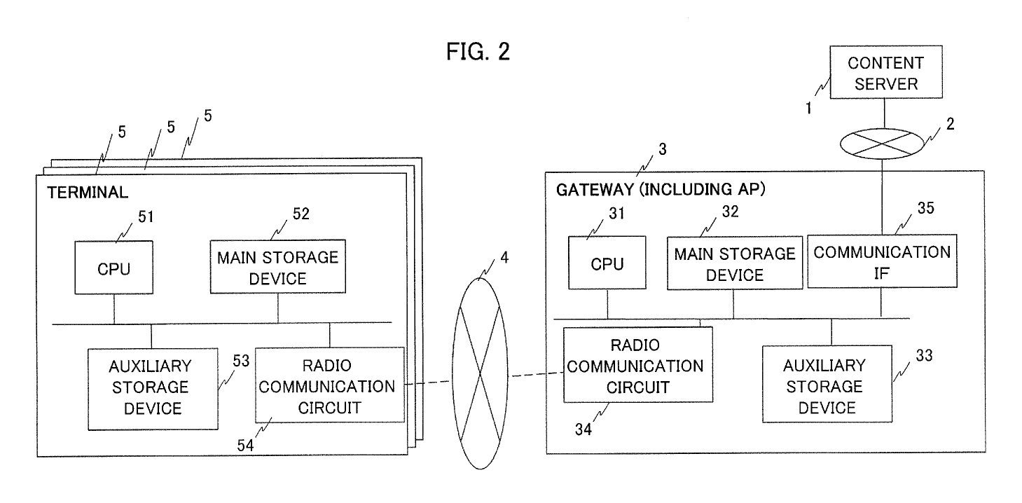

FIG. 2 is a view illustrating hardware configuration examples of the terminal and the gateway. In FIG. 2, the gateway 3 (including an AP) includes a central processing unit (CPU) 31, a main storage device 32, an auxiliary storage device 33, a radio communication circuit 34 and a communication interface (communication IF) 35 which are connected to each other through a bus. The communication IF 35 is connected to the content server 1 through the wired network 2.

The terminal 5 includes a CPU 51, a main storage device 52, an auxiliary storage device 53, a radio communication circuit 54 and an antenna (not illustrated in the drawing) that are connected to each other through a bus. The terminal 5 and the gateway 3 perform wireless communication through the wireless network 4. The terminal 5 is, for example, a portable terminal that has a wireless communication function. However, the terminal 5 is not limited to such a terminal, and can include a terminal that has a communication IF and performs wired communication, and a terminal that is fixedly installed. In the first embodiment, the terminal 5 that is portable and has a wireless function is illustrated as one example.

The content server 1 will now be described. Although not illustrated in the drawings, the content server 1 includes a CPU, a main storage device, an auxiliary storage device and a communication interface that are connected to each other through a bus. Content data for videos, images and music are stored in the auxiliary storage device. A plurality of items of content data having different image sizes and transmission bit rates and the like that relate to original videos, images and music are stored as the content data. The CPU loads a program that is stored in the auxiliary storage device or the main storage device, to the main storage device and executes the program. Thereby, the CPU performs processing (control) to read out content data from the auxiliary storage device in accordance with a request from the terminal 5, and transmit the content data to the terminal 5 using the communication IF.

For example, a general-purpose computer such as a personal computer (PC) or a workstation (WS) can be applied as an information processing device (computer) that is used as the content server 1. Alternatively, a dedicated computer such as a server machine can be applied as the content server 1. However, there are also cases in which a computer other than the aforementioned PC, WS, and server machine is used as the content server 1.

The main storage device (for example, the main storage device 32, the main storage device 52, or the main storage device included in the content server 1) is used as a program expansion area, a work area for a CPU (for example, the CPU 31, the CPU 51, or the CPU included in the content server 1), an area for storing data or programs, or a buffer area. The main storage device is, for example, formed in combination with a random access memory (RAM) or a read only memory (ROM).

The auxiliary storage device (for example, the auxiliary storage device 33, the auxiliary storage device 53, or the auxiliary storage device included in the content server 1) is used as a region that stores data or programs. The auxiliary storage device is, for example, formed of a nonvolatile storage medium such as a hard disk drive (HDD), a solid state drive (SSD), a flash memory or an electrically erasable programmable read-only memory (EEPROM). A recording medium having portability such as a disk-type storage medium or a USB memory can also be included as the auxiliary storage device. The main storage device and the auxiliary storage device are examples of a “storage device”, a “storage medium”, a “memory” and a “storage unit”.

The radio communication circuit (for example, the radio communication circuit 34 or the radio communication circuit 54) includes a baseband circuit (BE circuit) and a radio frequency (RF) circuit. The BB circuit performs conversion processing between a data (digital) signal and a baseband signal (BB signal). The RF circuit performs conversion processing between a BB signal and a radio signal. A radio signal is transmitted and received by means of an antenna (not illustrated in the drawing).

The communication IF (for example, the communication IF 35 or the communication IF included in the content server 1) is a communication interface circuit that performs processing to transmit and receive packets and the like. For example, a network card referred to as a “LAN card” or a “network interface card” can be applied as the communication IF.

The CPU (for example, the CPU 31, the CPU 51, or the CPU included in the content server 1) loads a program that is stored in at least one of the main storage device and the auxiliary storage device to the main storage device and executes the program. The CPU 31 performs operations or processing as the gateway 3 by executing a program. The CPU 51 performs operations or processing as the terminal 5 by executing a program. The CPU is one example of a “control device”, a “control unit”, a “controller” or a “processor”.

The CPU is also referred to as an MPU (microprocessor) or a processor. The CPU is not limited to a single processor, and may have the configuration of a multiprocessor. Further, a single CPU that is connected with a single socket may have a multicore configuration. At least one part of processing performed with the CPU may be performed with a processor other than the CPU, for example, a dedicated processor such as a digital signal processor (DSP), a graphics processing unit (GPU), a numerical processor, a vector processor or an image processing processor.

Further, at least one part of processing performed by the CPU may be performed by an integrated circuit (IC) or another digital circuit. The integrated circuit or digital circuit may include an analog circuit. The term “integrated circuit” includes an LSI, an application specific integrated circuit (ASIC), and a programmable logic device (PLD). The PLD includes, for example, a field-programmable gate array (FPGA). At least one part of processing performed at the CPU may be executed by a combination of a processor and an integrated circuit. The combination is referred to, for example, as a microcontroller (MCU), an SoC (system-on-a-chip), a system LSI or a chip set.

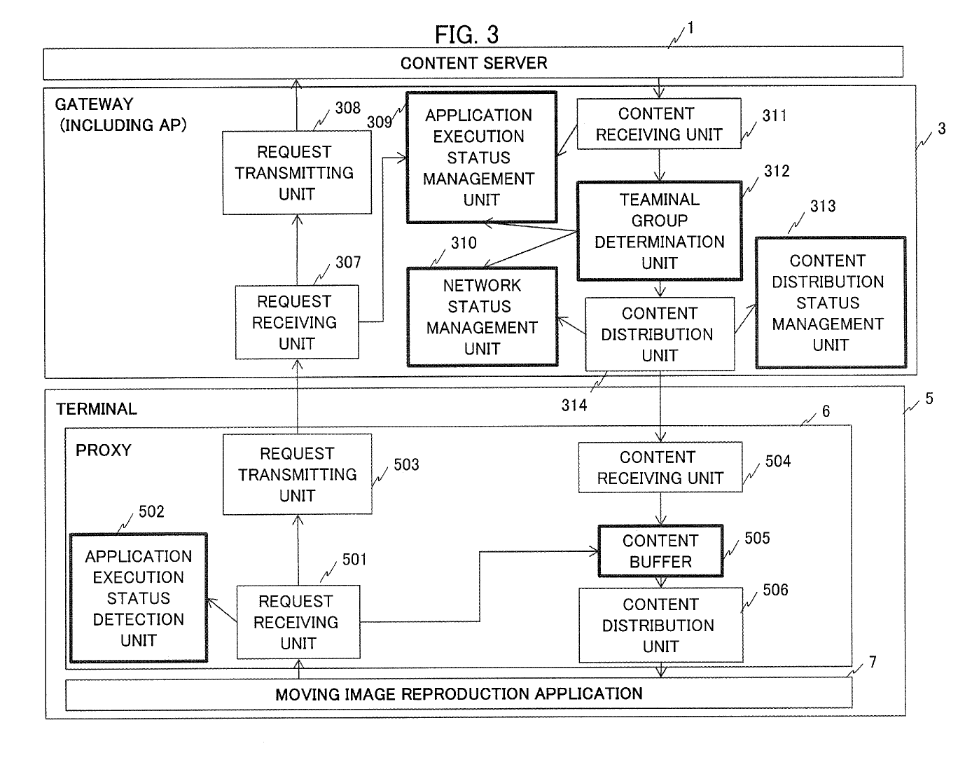

FIG. 3 schematically illustrates functions of the gateway 3 and the terminal 5. In FIG. 3, by executing a program, the CPU 31 of the gateway operates as a request receiving unit 307, a request transmitting unit 308, an application execution status management unit 309 and a network status management unit 310. Further, by executing a program, the CPU 31 of the gateway operates as a content receiving unit 311, a terminal group determination unit 312, a content distribution status management unit 313 and a content distribution unit 314. The CPU 31 uses the communication IF 35 and the radio communication circuit 34 for transmitting and receiving requests and content. The terminal group determination unit 312 (the CPU 31) is an example of a “grouping unit” and a “determination unit”, as well as a “setting unit” according to a second embodiment.

By executing a program, the CPU 51 of the terminal 5 causes the terminal 5 to operate as a device that includes the proxy 6 and the moving image reproduction application 7. By executing a program, the CPU 51 operates as a request receiving unit 501, an application execution status detection unit 502, a request transmitting unit 503, a content receiving unit 504, a content buffer 505 and a content distribution unit 506 that are included in the proxy 6.

It is taken as a premise that the moving image reproduction application 7 sends a request provided by a playlist to the content server 1, and the content server 1 transmits a playlist to the moving image reproduction application. The proxy 6 performs relay processing for the request and the response (playlist).

The request receiving unit 501 of the terminal 5 receives a moving image acquisition request from the moving image reproduction application 7. The application execution status detection unit 502 detects a reproduction position of the moving image content (a position on a reproduction time axis of the content) and an allowable distribution delay time. The allowable distribution delay time is a time period on the aforementioned reproduction time axis of content that is cached inside the moving image reproduction application 7. The term “allowable distribution delay time” means a maximum time period in which moving image reproduction is not delayed (is not stopped or interrupted) even if distribution of content to the terminal is delayed.

The reproduction position and allowable distribution delay time of the moving image content are, for example, included in a header of a request to acquire a fragment of the moving image content from the moving image reproduction application 7. However, the reproduction position and allowable distribution delay time of the moving image content may also be estimated based on the request transmission behavior of the moving image reproduction application 7 or calculated based on the contents of the playlist.

The request transmitting unit 503 of the terminal 5 transmits a request from the moving image reproduction application 7 to the gateway 3. At such time, as the identifier of the terminal 5, the request transmitting unit 503 attaches the MAC address of the terminal to the header of the request.

The content receiving unit 504 of the terminal 5 receives a content fragment that is transferred through the wireless network 4 by unicast distribution or multicast distribution from the gateway 3.

The content buffer 505 temporarily stores the content fragment that is received from the gateway 3. Since the “processing 1” and “processing 2” that were described above using FIG. 1 are executed asynchronously, the proxy 6 of the terminal 5 waits for content fragments. In particular, the following possibility exists in a case where a content fragment is distributed by multicast from the gateway 3 to the terminal 5. That is, there is a possibility that, before the moving image reproduction application 7 actually transmits a request to the content server 1, a content fragment is distributed in accordance with a request from a terminal 5 that belongs to the same group.

Therefore, a configuration is adopted that, until a request is actually generated from the moving image reproduction application 7, stores a content fragment in association with a URL (uniform resource locator) of a request so that a content fragment can be provided to the moving image reproduction application 7.

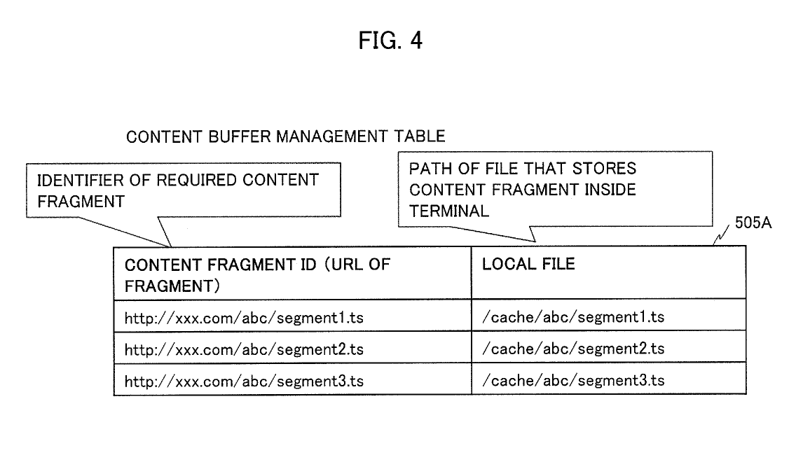

FIG. 4 illustrates an example of the data structure of a content buffer management table 505A. The content buffer management table 505A stores IDs of content fragments in association with paths of local files (storage locations of content fragments). The content buffer 505 and the content buffer management table 505A are generated by the CPU 51, and are stored in at least one of the main storage device 52 and the auxiliary storage device 53. The content distribution unit 506 of the terminal 5 reads out a content fragment from the content buffer 505 at a predetermined timing, and transfers the content fragment to the moving image reproduction application 7.

The request receiving unit 307 of the gateway 3 receives a request from the terminal 5, extracts application execution status information, a terminal ID (identifier of the terminal 5), and the URL of the content fragment that is the acquisition object which are included in the request, and passes these to the application execution status management unit 309. The request transmitting unit 308 of the gateway 3 transmits the request from the terminal 5 to the content server 1.

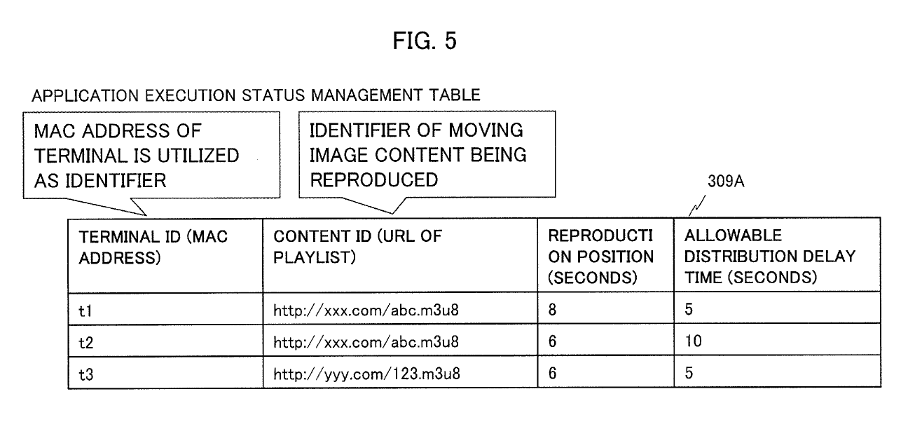

The application execution status management unit 309 manages the reproduction status of moving image content for each terminal 5. FIG. 5 illustrates an example of the data structure of an application execution status management table 309A. The application execution status management table 309A is managed by the application execution status management unit 309. The application execution status management table 309A is a set of records (entries) that are formed for each terminal 5. Each record includes a terminal ID, a content ID, a reproduction position of the content, and an allowable distribution delay time. The application execution status management table 309A is generated by the CPU 31, and is stored in at least one of the main storage device 32 and the auxiliary storage device 33. The MAC address of the terminal 5 can be applied as the terminal ID. However, terminals may be managed using an identifier other than the MAC address. Further, terminals may be managed using both the MAC address and an identifier other than the MAC address.

Each time a request to acquire a content fragment included in the playlist is received, the application execution status management unit 309 updates a corresponding record of the application execution status management table 309A. A record is deleted in a case where, for example, a predetermined time period (one day or the like) passes from the time that the record is first added. Checks with respect to an elapsed time period and deletion can be executed at regular intervals or non-regular intervals. Further, a record may be deleted at a time point at which the final content fragment listed in the playlist is acquired.

The network status management unit 310 manages the usage status (for unicast and multicast, respectively) of a wireless bandwidth (wireless network 4). If the gateway is integrated with an AP, as in the case of the gateway 3, bandwidth usage information can be acquired as a function of the AP. However, the usage status (bandwidth usage) of a wireless bandwidth may also be calculated based on the actual data transfer amount and transfer time by the content distribution unit 314. In a case where the gateway and the AP are separated, the usage status may also be acquired from an external API (application programming interface) of the AP or a management system (that manages the usage status of a wireless bandwidth) of a wireless network apparatus that can communicate with the gateway 3.

The content receiving unit 311 receives content fragments from the content server 1. The terminal group determination unit 312 determines (decides) terminals that are to be grouped (groups to which respective terminals belong) and a distribution mode (multicast or unicast) of content fragments based on the application execution status of the terminal 5 and the usage status of the wireless network 4.

For each terminal 5, the content distribution status management unit 313 manages the IDs (identifiers) of content fragments that are transmitted to the terminal 5. In some cases, multicast distribution arises as the result of a request from a terminal 5 that is other than a certain terminal 5, and which belongs to the same group as the certain terminal 5 and for which a reproduction position is ahead of a reproduction position of the certain terminal 5. In such a case, to avoid duplicate distribution of the same content fragment, information indicating the terminal 5 that is the distribution destination of each content fragment is managed.

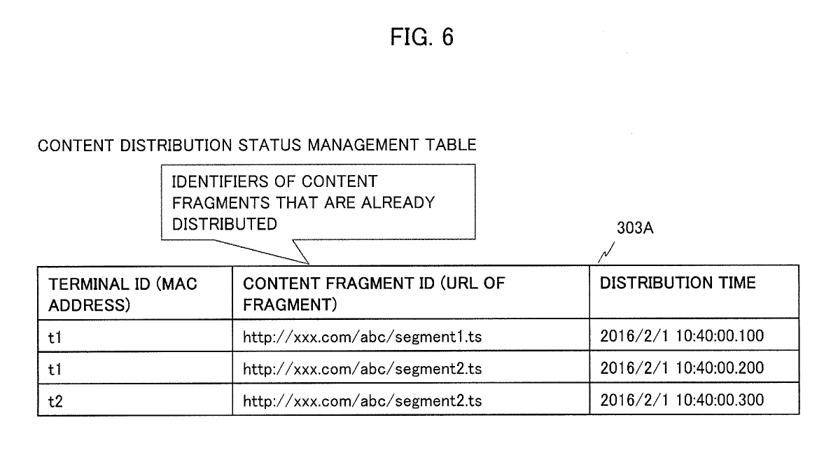

FIG. 6 is an example of the data structure of a content distribution status management table 303A that is managed by the content distribution status management unit 313. The content distribution status management table 303A includes records that correspond to respective terminals 5. The records include a terminal ID, a content fragment ID and a distribution time. Deletion of records is executed, for example, at fixed intervals. However, a configuration may also be adopted in which a record is deleted in response to a deletion request. The content distribution status management table 303A is generated by the CPU 31, and is stored in at least one of the main storage device 32 and the auxiliary storage device 33.

The content distribution unit 314 distributes content fragments to the terminals 5 in accordance with the distribution method (unicast or multicast) that is decided by the terminal group determination unit 312. When distributing content fragments, the content distribution unit 314 refers to the distribution status (content distribution status management table 303A) which the content distribution status management unit 313 manages, and avoids duplicate distribution of the same content.

<Flow of “Processing 1”>

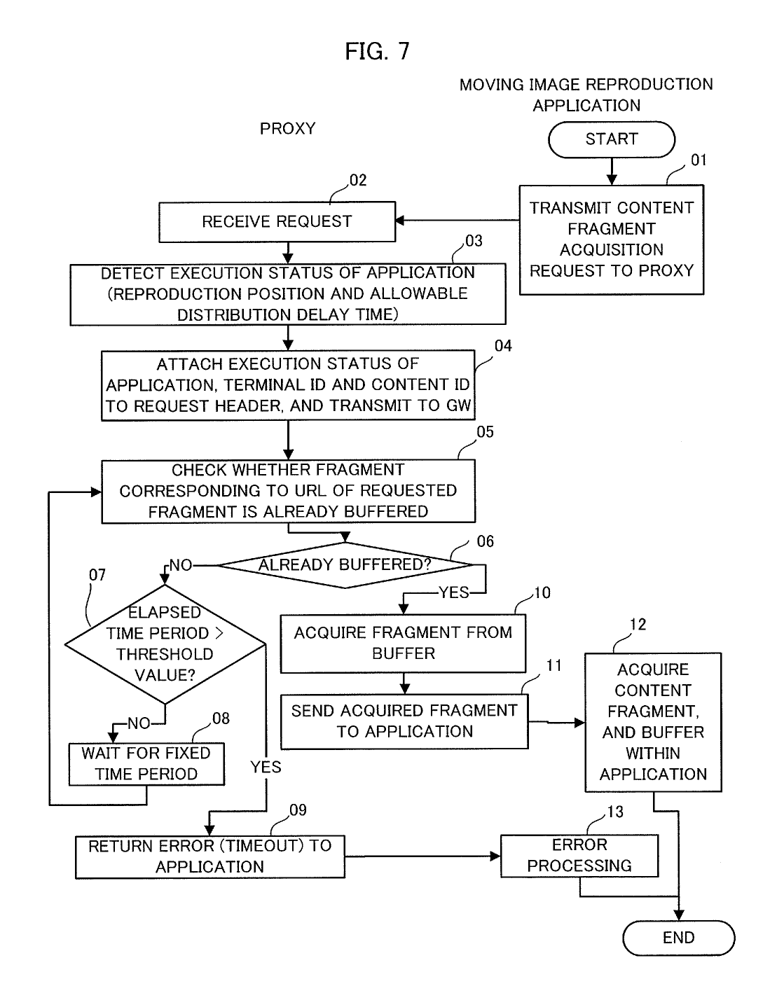

FIG. 7 is a flowchart illustrating an example of the processing 1 (processing that provides a content fragment to an application). The processing illustrated in FIG. 7 is executed by the CPU 31 that operates as the moving image reproduction application 7 and the proxy 6.

In FIG. 7, the moving image reproduction application 7 (hereunder, also described as “application 7”) transmits an acquisition request (hereunder, also described as “request”) for a content fragment (hereunder, also described as simply “fragment”) to the proxy 6 (01).

At the proxy 6, upon receiving the request from the application 7 (02), the request receiving unit 501 detects an execution status (reproduction position and allowable distribution delay time) of the application 7 using the application execution status detection unit 502 (03).

In 04, the request receiving unit 501 attaches the execution status, the terminal ID and the content ID of the application 7 to the header of the request. The request transmitting unit 503 transmits the request to the gateway 3 (hereunder, also referred to as “GW 3”). The request is received by the request receiving unit 307 of the GW 3.

In the processing in 05, the request receiving unit 501 checks whether or not a fragment corresponding to the URL of the (requested) fragment relating to the request is already buffered in the content buffer 505, to thereby determine whether or not the fragment is already buffered (06).

When it is determined in 06 that the fragment is not already buffered (“No” in 06), the request receiving unit 501 determines whether or not the elapsed time period exceeds a threshold value. When it is determined that the elapsed time period does not exceed the threshold value (“No” in 07), the processing is returned to 05 after waiting for a fixed time period. On the other hand, when it is determined that the elapsed time period exceeds the threshold value (“Yes” in 07), the processing proceeds to 09. In the processing in 09, an error (timeout) is returned to the application 7 as a response to the request.

On the other hand, when it is determined in 06 that the fragment is already buffered (“Yes” in 06), the content distribution unit 506 acquires the relevant fragment from the content buffer 505 (10), and sends the fragment to the application 7 (11).

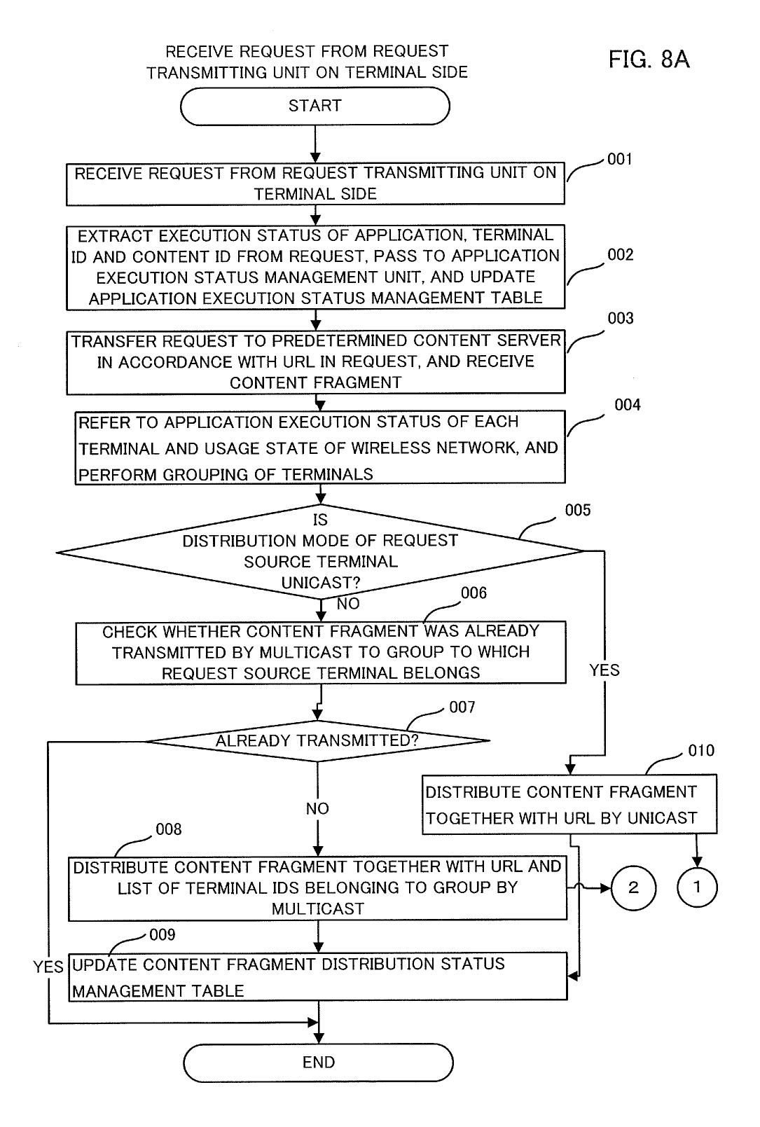

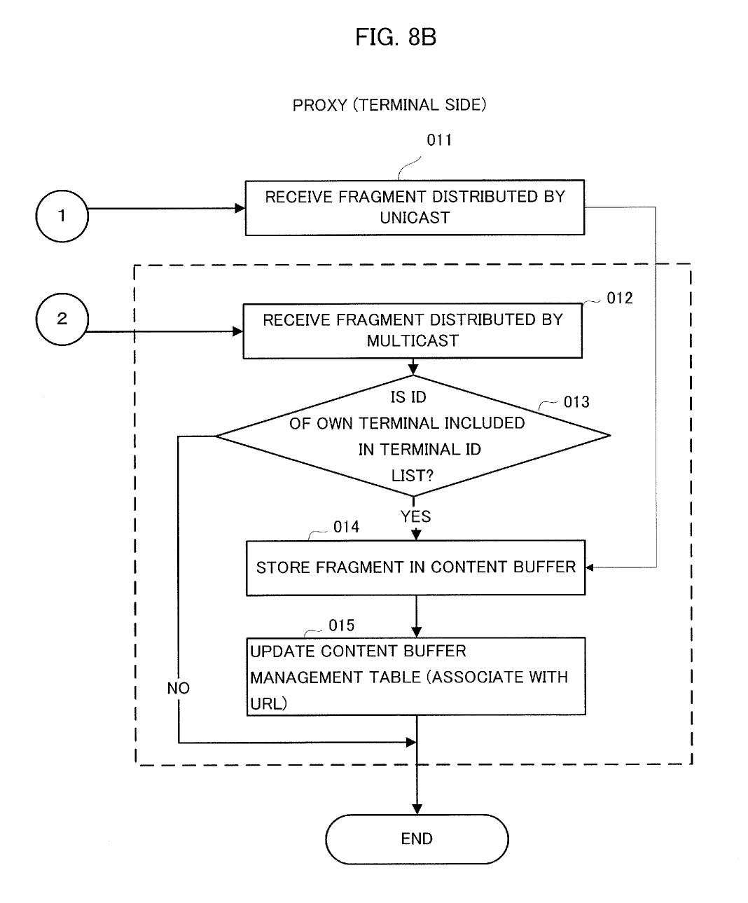

The application 7 acquires the fragment, and buffers the fragment within the application 7. The fragment that is buffered is used in content reproduction processing. Note that, in a case where an error is notified from the proxy in 09, the application 7 performs predetermined error processing (13). After the end of the processing in 12 or 13, the processing in FIG. 7 ends.

<Flow of “Processing 2”> FIG. 8A and FIG. 8B are flowcharts that illustrate an example of the processing 2 (processing that distributes a fragment of content requested (required) by an application to a terminal). FIG. 8A illustrates processing performed at the gateway 3. FIG. 8B illustrates processing performed at the terminal 5. The processing at the gateway 3 is performed by the CPU 31. The processing at the terminal 5 is performed by the CPU 51.

In FIG. 8A, the request receiving unit 307 receives a request from the request transmitting unit 503 (001). The request receiving unit 307 extracts the execution status of the application, the terminal ID, and the content ID from the request, and passes these to the application execution status management unit 309. The application execution status management unit 309 updates the application execution status management table 309A (FIG. 5) (002).

In 003, the request transmitting unit 308 transfers the request to a predetermined content server 1 in accordance with the URL contained in the request. The content server 1 transmits a fragment of content corresponding to the request, and the content receiving unit 311 receives the fragment.

In 004, the terminal group determination unit 312 refers to the application execution status of each terminal 5 and the usage status of the wireless network 4, and carries out grouping of terminals (the details of this processing are described later).

In 005, based on the grouping result, the content distribution unit 314 determines whether the distribution mode for distribution to the source terminal of the request is unicast or multicast. At this time, when it is determined that the distribution mode is unicast (“Yes” in 005), the processing proceeds to 010. On the other hand, when it is determined that the distribution mode is multicast (“No” in 005), the processing proceeds to 006.

In 006, the content distribution status management unit 313 (management unit 313) checks whether or not the fragment has already been transmitted by multicast to the group to which the source terminal of the request belongs. The content distribution status management unit 313 performs this check by referring to the content distribution status management table 303A.

In 007, the content distribution unit 314 determines whether or not the fragment has already been transmitted based on the result of the check performed by the management unit 313. When it is determined that the fragment was already transmitted (“Yes” in 007), the processing in FIG. 8A ends. On the other hand, when it is determined that the fragment was not already transmitted (“No” in 007), the processing proceeds to 008.

In 008, the content distribution unit 314 distributes the fragment by multicast together with a URL and a list of terminal IDs that belong to the group. In 009, the content distribution status management unit 313 updates the content distribution status management table 303A in response to the distribution.

When the processing proceeded to 010, the content distribution unit 314 distributes the fragment by unicast together with a URL and a list of terminal IDs that belong to the group. Thereafter, the processing proceeds to 009.

At the terminal 5, in 011, the content receiving unit 504 receives the fragment that is distributed by unicast, and advances the processing to 014. In 012, the content receiving unit 504 receives the fragment that is distributed by multicast, and advances the processing to 013.

In 013, the content receiving unit 504 determines whether or not the terminal ID of its own terminal is included in the terminal ID list (whether the received data is a packet (fragment) of a multicast group in which the terminal 5 is participating). When it is determined that the terminal ID is not included (“No” in 013), the processing in FIG. 8B ends (the fragment is not saved). When it is determined that the terminal ID is included (“Yes” in 013), the processing proceeds to 014.

In 014, the fragment is saved (stored) in the content buffer 505. Further, the content buffer management table 505A (FIG. 4) is updated. The fragment and the URL are associated. Thereafter, the processing in FIG. 8B ends.

The processing that is surrounded by a dashed-line rectangle in FIG. 8B is not related to generation of a content fragment acquisition request, and is executed in a case where a packet (fragment) that is distributed by multicast is received.

In the case of multicast distribution, depending on the timing at which a request for the same content fragment arises from another terminal 5, a case can occur in which distribution of a content fragment to the terminal 5 is not performed. Conversely, a case can also arise in which distribution of a content fragment occurs even without transmitting a request.

<Terminal Grouping Processing>

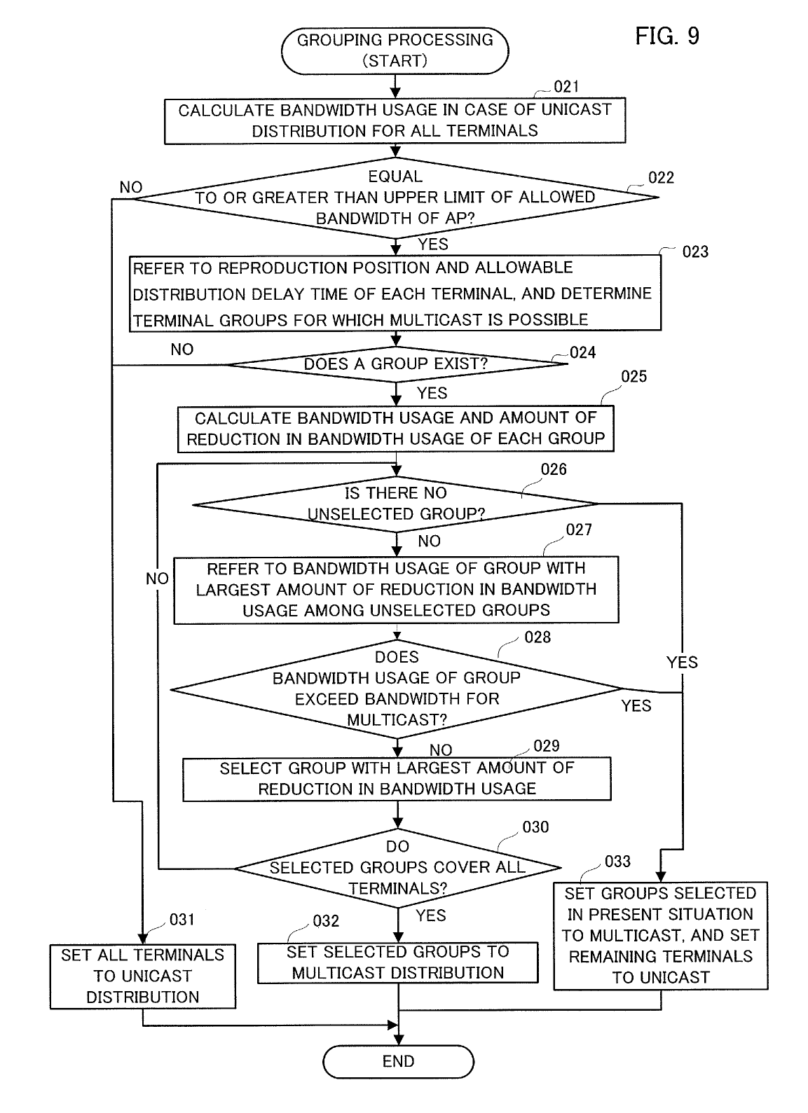

FIG. 9 is a flowchart that illustrates processing for grouping terminals. The processing illustrated in FIG. 9 is performed by the CPU 31 that operates as the terminal group determination unit 312 (determination unit 312). In the processing in 021, the determination unit 312 calculates the bandwidth usage for a case where unicast distribution is performed for all the terminals 5.

In the processing in 022, the determination unit 312 determines whether or not the bandwidth usage is equal to or greater than an upper limit of an allowed bandwidth of the AP. When it is determined that the bandwidth usage is equal to or greater than the upper limit of the allowed bandwidth of the AP (“Yes” in 022), the processing proceeds to 023. On the other hand, when it is determined that the bandwidth usage is less than the upper limit of the allowed bandwidth of the AP (“No” in 022), the processing proceeds to 031.

In the processing in 023, the determination unit 312 refers to the reproduction position and the allowable distribution delay time of each terminal 5, and determines terminal groups for which multicast is possible (sets each of the respective groups to “unselected”). In 023, a group that is a subset of a certain group is excluded. Further, it is also possible to adopt a configuration that determines a transmission rate for each terminal based on the radio field intensity from the terminals 5, and does not group terminals in a case where the transmission rate will become large, even if the content reproduction positions of the terminals are near each other.

In the processing in 024, it is determined whether or not a group exists that was determined in 023. When it is determined that a group does not exist (“No” in 024), the processing proceeds to 031. When it is determined that a group exists (“Yes” in 024), the processing proceeds to 025.

In the processing in 025, the determination unit 312 calculates the bandwidth usage of each group, and the amount of reduction in the bandwidth usage that will be obtained by changing to multicast distribution. In 026, the determination unit 312 determines whether or not there is an unselected group. When there is not an unselected group (“Yes” in 026), the processing proceeds to 033. When there is an unselected group (“No” in 026), the processing proceeds to 027.

In 027, the determination unit 312 refers to the bandwidth usage of the group for which the amount of reduction in the bandwidth usage is largest among the unselected groups. In 028, the determination unit 312 determines whether or not the bandwidth usage of the group exceeds the bandwidth for multicast. When it is determined that the bandwidth usage of the group exceeds the bandwidth for multicast (“Yes” in 028), the processing proceeds to 033. On the other hand, when it is determined that the bandwidth usage of the group is less than or equal to the bandwidth for multicast (“No” in 028), the processing proceeds to 029.

In the processing in 029, the group for which the amount of reduction in the bandwidth usage is largest is selected by the determination unit 312 as a group for which multicast distribution is to be applied. In the processing in 030, the determination unit 312 determines whether or not all of the terminals are covered by groups that have been selected up to the current time. That is, the determination unit 312 determines whether all the terminals 5 belong to any one of the groups for which multicast is selected. When all of the terminals are covered (“Yes” in 030), the processing proceeds to 032. When all of the terminals are not covered (“No” in 030), the group selected in 029 is set to “selected” (the setting “unselected” is cancelled) and the processing returns to 026. In 026, the processing from 027 to 030 is performed for an unselected group that is other than the group selected in 029.

When the processing proceeds to 031, the determination unit 312 decides to set unicast as the distribution mode for all the terminals 5. When the processing proceeds to 032, the determination unit 312 decides to set multicast as the distribution mode for all the terminals 5 (all terminals) that belong to selected groups. When the processing proceeds to 033, the determination unit 312 sets multicast as the distribution mode for groups that are selected (have already been selected) under the present situation. On the other hand, the determination unit 312 decides to set unicast as the distribution mode for the remaining terminals 5 that do not belong to a selected group.

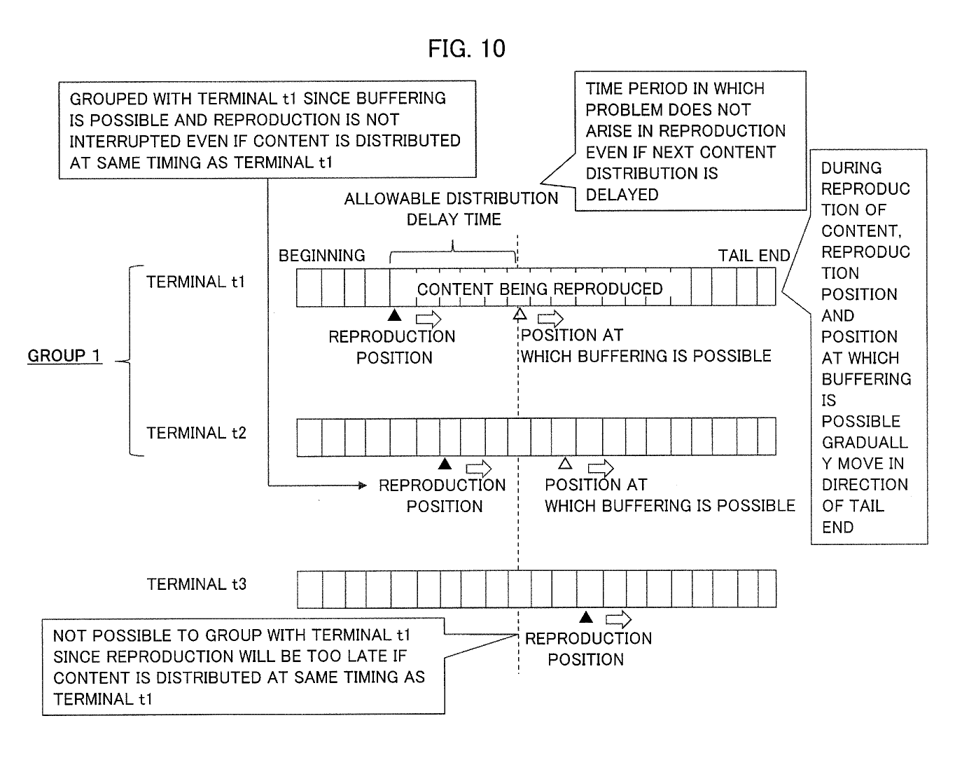

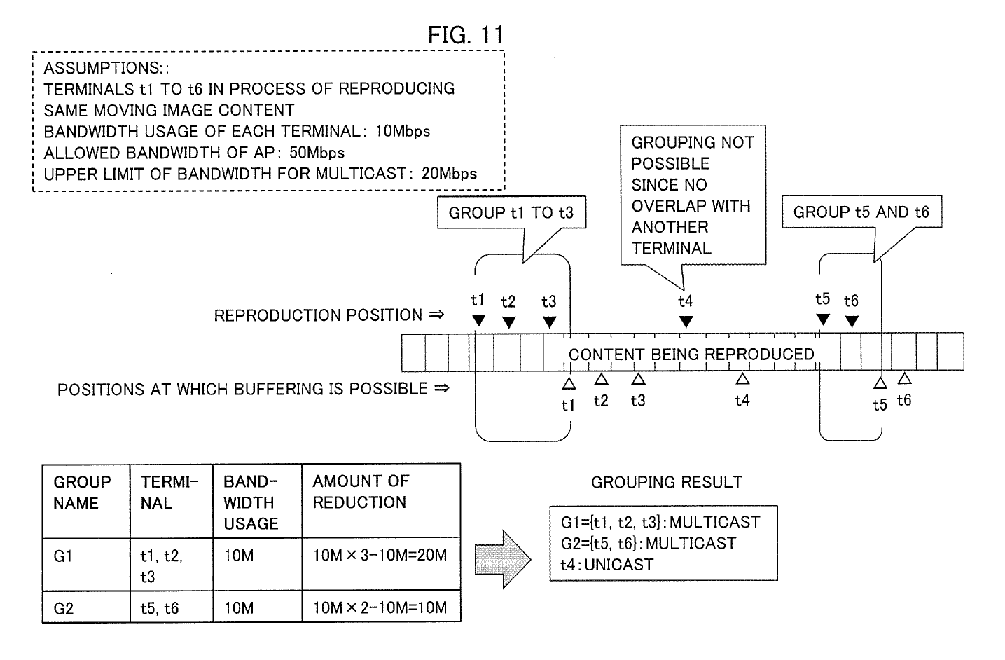

FIG. 10 and FIG. 11 are drawings for explaining grouping. FIG. 10 describes the fundamental concept with respect to cases where grouping is possible and cases where grouping is not possible. For example, it is assumed that there are three terminals, namely, terminal t1, terminal t2 and terminal t3 that are in the process of reproducing the same content. The entire content that each terminal is reproducing is represented by rectangles, which indicates that the content is divided into a plurality of fragments. As the reproduction time period passes, the reproduction position of the content moves from the beginning (left end of the rectangles) in the direction of the tail end (right end). A reproduction position (reproduction time point) and a position at which buffering is possible (time when buffering is possible) are prescribed for the content, and the reproduction position and the position at which buffering is possible move in the direction of the tail end accompanying the passage of time.

A time period between the reproduction time point and the time when buffering is possible is the allowable distribution delay time, and during this period the reproduction of content is performed using a fragment stored in the content buffer 505. Hence, reproduction is performed without interruption or stoppage as long as the next fragment is supplied before the allowable distribution delay time passes.

In this case, when attention is focused on the terminal t2 it is found that the reproduction position of the terminal t2 is inside the allowable distribution delay time of the terminal t1. Therefore, when distribution of a fragment is performed so that the next fragment is supplied within the aforementioned allowable distribution delay time, buffering is possible, and reproduction is not interrupted or stopped. The determination unit 312 groups the terminal t1 and the terminal t2 into the same group (for example, a group 1). The terminal t1 is an example of a “first distribution destination”, and the terminal t2 is an example of a “distribution destination other than the first distribution destination whose reproduction position lies inside a predetermined time period corresponding to the first distribution destination”. In contrast, the reproduction position of the terminal t3 is outside the allowable distribution delay time of the terminal t1, and therefore the distribution timing of a fragment thereto cannot be aligned with the terminal t1. Hence, the terminal t3 is not grouped into the same group as the terminal t1.

FIG. 11 illustrates an example of grouping. It is assumed that terminals t1 to t6 are in the process of reproducing the same moving image content. The bandwidth usage of each terminal is 10 Mbps. The allowed bandwidth of the AP is 50 Mbps. The upper limit of the bandwidth for multicast is 20 Mbps.

In a case where the reproduction positions (reproduction time points) and positions at which buffering is possible (times when buffering is possible) of the terminals t1 to t6 are in the states illustrated in FIG. 11, the reproduction positions of the terminal t2 and the terminal t3 are inside the allowable distribution delay time of the terminal t1. Therefore, the determination unit 312 groups the terminals t1 to t3 into the same group G1. Further, since the reproduction position of the terminal t6 is inside the allowable distribution delay time of the terminal t5, the determination unit 312 groups the terminal t5 and the terminal t6 into the same group G2. A group list 312A that the determination unit 312 manages is illustrated in the lower left part of FIG. 11. The amount of reduction for the group G1 is 20 Mbps, since the respective bandwidths of 10 Mbps of the terminals t1 to t3 are consolidated into a single bandwidth by multicast. On the other hand, the amount of reduction of the group G2 is 10M bps, since the respective bandwidths of terminal t5 and t6 are consolidated into a single bandwidth.

In the processing in 027 illustrated in FIG. 9, the group G1 is selected. Because the bandwidth usage of 10 Mbps of the group G1 does not exceed the bandwidth for multicast of 20 Mbps, the group G1 is selected in the processing in 029. In the processing in 030, since the group G1 does not cover all of the terminals, the processing in 027 to 030 is performed for the group G2. Thereafter, the processing transitions to 026 from 030. Since a group other than the groups G1 and G2 does not exist, the processing transitions to 033. As illustrated as a grouping result in FIG. 11, multicast distribution is determined for the group G1 (terminals t1, t2 and t3), and multicast distribution is determined for the group G2 (terminals t5 and t6). Since it is not possible for the terminal t4 to belong to any of the groups, unicast is determined as the distribution mode for the terminal t4.

### Effects of First Embodiment

In the first embodiment, a plurality of terminals 5 are provided as an example of “a plurality of distribution destinations of content that is reproducible at a different reproduction position at each distribution destination”, and the gateway 3 is provided as an example of “a content distribution control apparatus that controls distribution of content to the plurality of distribution destinations”.

The gateway 3 includes the determination unit 312 (CPU 31) as a grouping unit that groups a plurality of distribution destinations based on a reproduction position of the content and information (allowable distribution delay time) indicating a predetermined time period from the reproduction position that is obtained from each terminal 5.

Further, the determination unit 312 (CPU 31) is an example of a determination unit that determines a method for distributing the content to groups formed by grouping, based on the usage status of a network used for distribution of content to a plurality of distribution destinations.

From among a plurality of distribution destinations (for example, terminals t1 to t6 (FIG. 11)), the determination unit 312 as a grouping unit groups a first distribution destination (terminal t1) and distribution destinations (terminals t2 and t3) which are other than the first distribution destination and whose reproduction positions lie inside a predetermined time period corresponding to the first distribution destination into a single group (G1).

The determination unit 312 as a determination unit determines whether or not multicast distribution of the content to a single group is possible based on the usage status of the wireless network 4 (028 in FIG. 9). When multicast distribution is possible, the determination unit 312 sets multicast distribution as the distribution method for the group G1. Thereby, since content distribution to the terminals t1, t2 and t3 is performed using a common bandwidth by multicast, the bandwidth usage of the wireless network 4 can be reduced. Thus, the first embodiment can enable a reduction in the bandwidth that is used for content distribution.

Further, in the first embodiment, in a case where a plurality of groups (for example G1 and G2) are formed, the determination unit 312 as a determination unit prioritizes the performance of a determination regarding the distribution method for a group for which the amount of bandwidth reduction obtained by multicast distribution is largest (see the processing in 027 to 029 in FIG. 9). Thereby, multicasting is switched to starting from the group in which the amount of reduction is largest, to thereby reduce the bandwidth usage.

According to the first embodiment, in the content distribution system (gateway 3) as illustrated in FIG. 1, grouping of the terminals 5 is performed based on the reproduction position of the moving image content as the execution status (reproduction status of the content) of the application and the allowable distribution delay time for each terminal 5. According to the grouping process, terminals for which distribution of content can be performed collectively, that is, terminals 5 other than a certain terminal 5 whose reproduction positions lie inside an allowable distribution delay time that is based on the reproduction position of the certain terminal 5 are grouped into the same group.

Based on the usage status of the wireless network 4 that is a supply network (network) for supplying content fragments to each terminal 5, it is decided which one of multicast and unicast to apply as the distribution method for distributing content (fragments) to each group. In the first embodiment, when the bandwidth usage of the terminals 5 belonging to each group is less than or equal to the bandwidth for multicast, multicast distribution is decided as the distribution method, and when the bandwidth usage is not less than or equal to the bandwidth for multicast, unicast distribution is decided as the distribution method.

Although prior to grouping, the fragments are supplied by unicast to the individual terminals 5, when multicast distribution is performed the fragments are supplied using a common bandwidth and therefore the bandwidth usage on the wireless network 4 is reduced. Hence, the occurrence of congestion is suppressed, and the occurrence of cases in which a user recognizes a decrease in the user's quality of experience (QoE) can be reduced (suppressed).

As described above, according to the first embodiment, in a case where a plurality of groups are formed, the priority for determining the distribution method is given to a group which realizes the largest amount of reduction in the bandwidth. Thereby, a group having a large bandwidth reducing effect is changed with priority to multicast distribution to thereby enable a reduction in the bandwidth usage.

### Second Embodiment

A second embodiment of the present invention is described hereunder. Since the second embodiment includes points that are common with the first embodiment, differences from the first embodiment are mainly described, and a description of the common points is omitted.

In the second embodiment, the number of terminals 5 which it is possible to group is increased by adjusting the reproduction speed of content by the moving image reproduction application 7 in a manner such that the user is not aware of the adjustment (the reproduction speed is adjusted to a degree that is not recognized by the user). Thereby, it is possible to reduce the bandwidth usage of the network (wireless network 4) that supplies the content and to decrease, relative to the first embodiment, the number of users that perceive a reduction in the QoE.

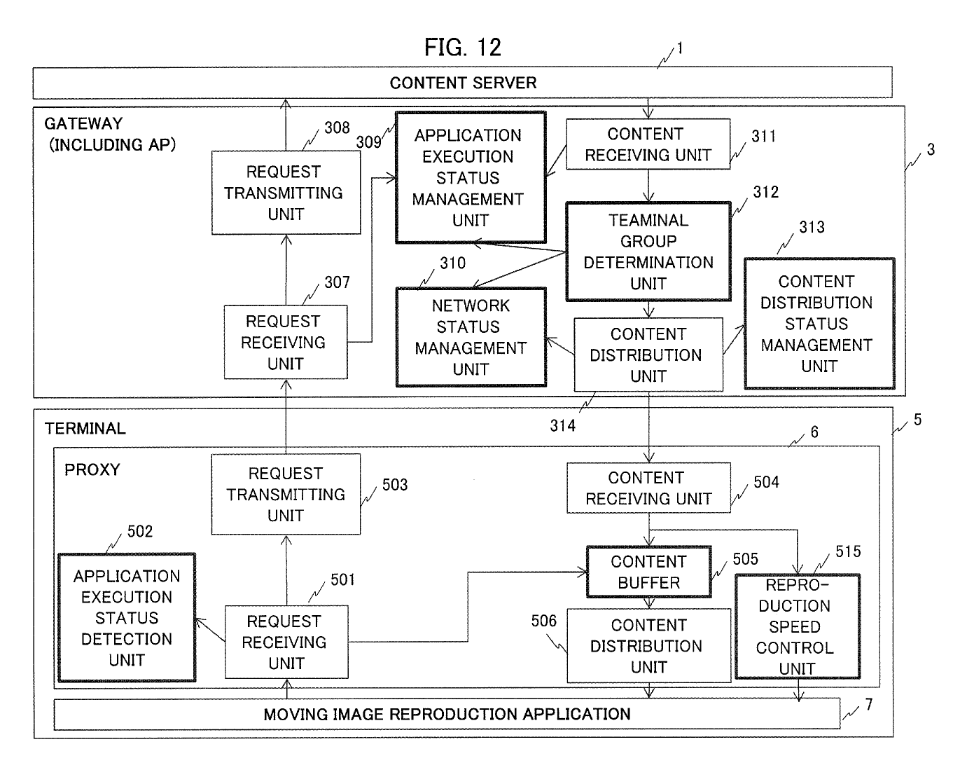

FIG. 12 is a view that illustrates a configuration example of the gateway 3 and the terminal 5 in the second embodiment. The same hardware configuration as in the first embodiment (FIG. 2) can be applied as the hardware configuration of the second embodiment.

Substantially the same configurations as in the first embodiment (FIG. 3) can be adopted for the gateway 3 and the terminal 5 in the second embodiment. However, the configurations in the second embodiment differ from the configurations in the first embodiment with respect to the following points.

(0) The proxy 6 of the terminal 5 further includes a reproduction speed control unit 515. The reproduction speed control unit 515 can increase or decrease the reproduction speed of content by the moving image reproduction application 7.

(1) The application execution status detection unit 502 on the terminal 5 side detects a reproduction speed, in addition to the reproduction position and the allowable distribution delay time.

The reproduction speed is a multiplying factor in a case where the normal reproduction speed is taken as, for example, 1.0. To ensure that a change in the reproduction speed is not a cause of concern to the user, an allowable range of the reproduction speed is kept to, for example, a range of ±0.1 (multiplication) around 1.0 (standard). However, the reproduction speed (multiplying factor) can be appropriately changed within a range in which the reproduction speed (multiplying factor) is not of concern to the user.

(2) The application execution status management unit 309 of the gateway 3 also manages the reproduction speed of each terminal.

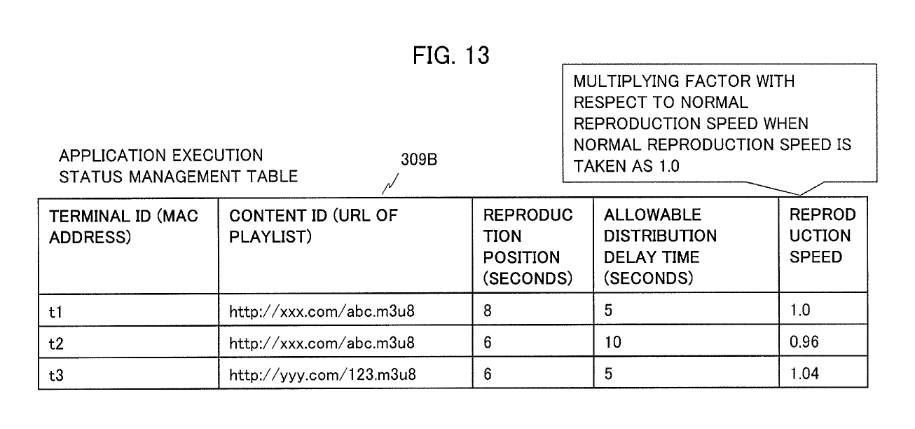

FIG. 13 illustrates an example of the data structure of an application execution status management table 309B in the second embodiment. As illustrated in FIG. 13, in addition to having the data structure of the application execution status management table 309A (FIG. 5) in the first embodiment, the reproduction speed is also stored in the application execution status management table 309B.

(3) The terminal group determination unit 312 of the gateway 3 performs grouping that takes into account a fact that it is possible to change the reproduction speed for each terminal 5.

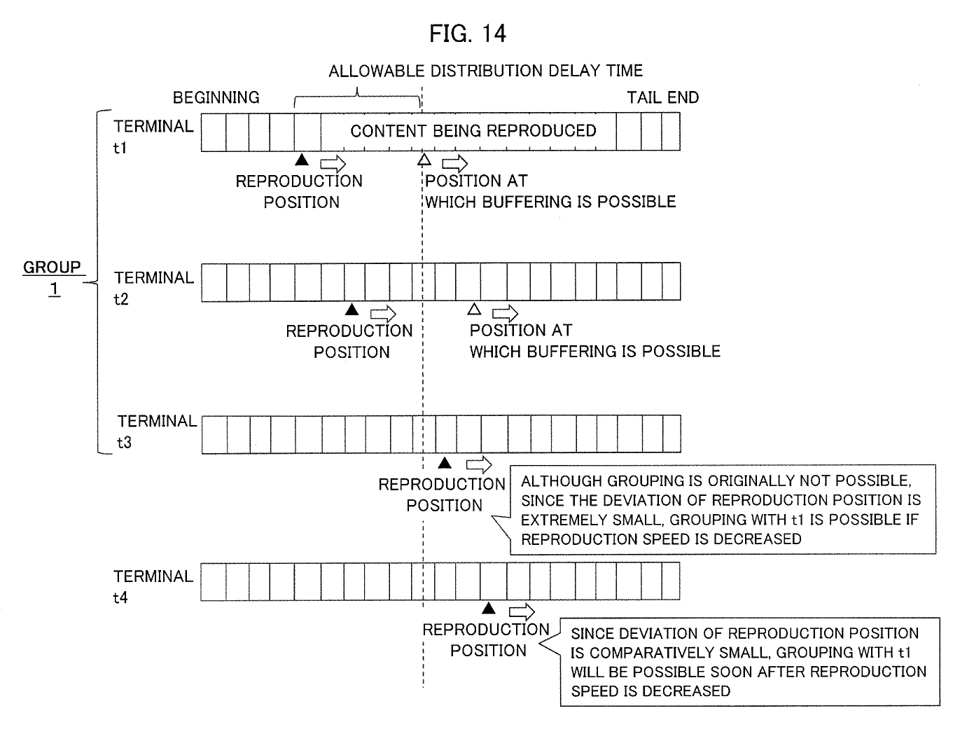

FIG. 14 is an explanatory drawing for describing a method for grouping terminals 5 in second embodiment (concept regarding grouping of terminals 5). A difference from the first embodiment is that the range of reproduction positions when performing grouping is evaluated as being somewhat larger than in the first embodiment.

For example, in the first embodiment, the terminal t3 in FIG. 14 is determined as not belonging to the group 1. In contrast, in the second embodiment, in a case where a time difference (deviation between reproduction positions) between a timing at which the allowable distribution delay time of the terminal t1 expires and the reproduction position of the terminal t3 is small, it is determined that it is possible to reduce the reproduction speed at the terminal t3 and group the terminal t3 in the same group as the terminal t1. Since the reproduction position deviation for the terminal t4 is somewhat large, although it is not possible to immediately group the terminal t4 with the terminal t1, it is considered that it is possible to reduce the reproduction speed and to then group the terminal t4 with the terminal t1 after a short time has passed. The terminal t1 is an example of a “first distribution destination” and the terminal t3 is an example of a “second distribution destination”.

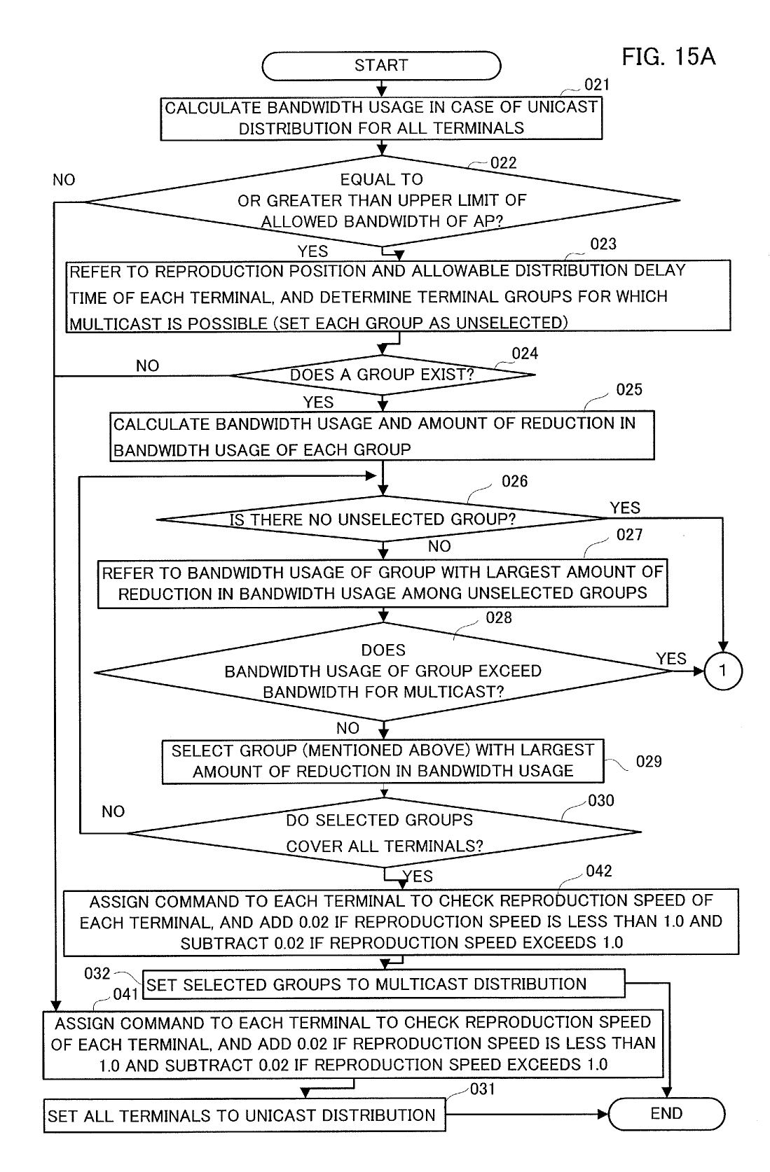

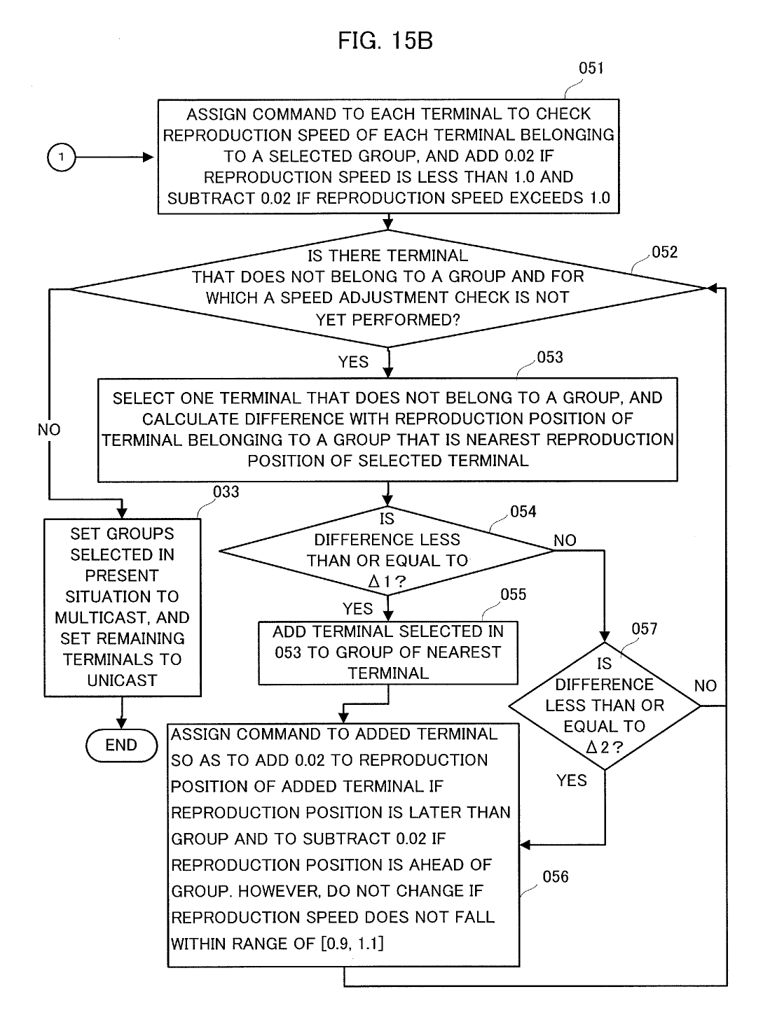

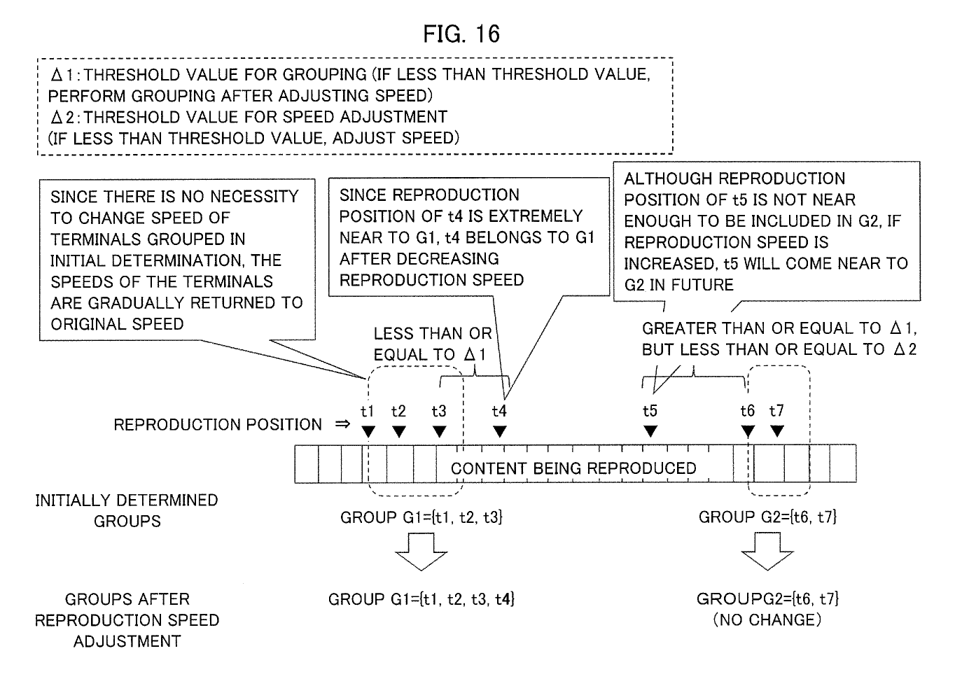

FIG. 15A and FIG. 15B are flowcharts that illustrate an example of grouping processing at a terminal in the second embodiment. The grouping processing in the second embodiment differs from the first embodiment (FIG. 9) in the respect that the processing in 041 and 042 in FIG. 15A and the processing in 051 to 057 in FIG. 15B are added in the second embodiment. FIG. 16 is an explanatory drawing of the grouping method in the second embodiment.

In the processing in 041 and 042, the determination unit 312 assigns, to each terminal 5, a command that instructs the moving image reproduction application 7 to check the reproduction speed of the respective terminals 5 and add 0.02 when the reproduction speed is less than 1.0 and subtract 0.02 when the reproduction speed exceeds 1.0. The assigned command is supplied to the moving image reproduction application 7 of each terminal 5. This is processing for gradually returning changed reproduction speeds to the original value of 1.0, because all the terminals have already been subjected to grouping or the bandwidths are originally ample, and hence there is no necessity to perform grouping and no need to adjust the reproduction speeds.

The processing in 051 is performed in a case where it was determined in 026 that there is no unselected group, and in a case where the bandwidth usage of the group exceeds the bandwidth for multicast. In 051, the determination unit 312 checks the reproduction speed of each terminal 5 that belongs to the selected group. At this time, a command for the moving image reproduction application 7 is assigned to each terminal 5 so as to add 0.02 when the reproduction speed is less than 1.0 and to subtract 0.02 when the reproduction speed exceeds 1.0.

In the processing in 052, the determination unit 312 determines whether or not there is a terminal that does not yet belong to a group and for which a speed adjustment check has not yet been performed. When there is no terminal for which a speed adjustment check has not been performed, the processing proceeds to 033. When there is a terminal for which a speed adjustment check has not been performed, the processing proceeds to 053.

In the processing in 053, the determination unit 312 selects one terminal 5 that does not belong to a group, and calculates a difference with a reproduction position of a terminal 5 which is in the vicinity of the reproduction position of the selected terminal 5 and which belongs to a certain group. At this time, when reproduction positions of terminals 5 that belong to separate groups on both sides of the selected terminal 5 exist, the determination unit 312 calculates a difference with respect to a reproduction position on the side nearest to the reproduction position.

In 054, the determination unit 312 determines whether or not the difference is less than or equal to a threshold value Δ1 for grouping. When the difference is less than or equal to the threshold value Δ1, the processing proceeds to 055. When the difference is not less than or equal to the threshold value Δ1, the processing proceeds to 057.

In 055, the determination unit 312 adds the terminal selected in 053 to the group to which the terminal 5 (nearest terminal) whose reproduction position was used for the difference calculation in 053 belongs. In 056, the determination unit 312 assigns (supplies) a command to the added terminal so as to add 0.02 to the reproduction speed of the terminal when the reproduction position of the terminal is later than the reproduction position of the group, and to make the reproduction speed a value obtained by subtracting 0.02 from the current reproduction speed thereof when the reproduction position of the added terminal is ahead of the reproduction position of the group. However, when the reproduction speed does not fall within a range of 1.0±0.1, that is, a range of [0.9≦reproduction speed≦1.1], the determination unit 312 does not change the reproduction speed. Thereafter, the processing returns to 052.

When the processing has proceeded to 057, the determination unit 312 determines whether or not the difference calculated in 053 is less than or equal to a threshold value Δ2 for speed adjustment. When the difference is less than or equal to the threshold value Δ2, the processing proceeds to 056, and although grouping of the terminal is not performed, the reproduction position of the terminal is brought close to the reproduction position of the nearest group. On the other hand, when the difference exceeds the threshold value Δ2, the processing returns to 052.

As illustrated in FIG. 16, it is assumed that terminals t1 to t7 which reproduce the same content exist, and the reproduction positions of the terminals t1 to t7 are distributed as illustrated in FIG. 16. Since the reproduction positions of the terminals t2 and t3 lie within an allowable distribution delay time (see the dashed-line frame) of the terminal t1, the terminals t2 and t3 are grouped in a group G1 (023 in FIG. 15A). Similarly, the terminal t6 and the terminal t7 are grouped in a group G2. The terminal t4 and the terminal t5 are not grouped. As a result of this processing, the processing advances from 026 to 051.

Because neither of the terminal t4 and the terminal t5 belongs to a group, adjustment of the reproduction speed is not performed in 051, and the processing proceeds to 053 since the situation conforms to the condition in 052.

In 053, for example the terminal t4 is selected from among the terminal t4 and the terminal t5. As illustrated in FIG. 16, the reproduction position of the terminal t3 that belongs to the group G1 is adjacent to the reproduction position of the terminal t4, on the left side thereof. Although the group 2 is present on the right side of the reproduction position of the terminal t4, because the reproduction position of the terminal t3 is nearer than the reproduction positions of the terminals t6 and t7 that belong to the group 2, the terminal t3 is regarded as the nearest terminal to the terminal t4. The determination unit 312 calculates the difference between the reproduction position of the terminal t4 and the reproduction position of the terminal t3 (053), and determines whether or not the difference is less than or equal to the threshold value Δ1 (054). At such time, when it is assumed that the difference is less than or equal to Δ1 (the reproduction position is very near to the group G1), the determination unit 312 adds the terminal t4 to the group G1 (055). In 056, because the terminal t4 is ahead of the group G1, the determination unit 312 subtracts 0.02 from the reproduction speed. Thereby, the reproduction position of the terminal t4 approaches the reproduction position of the terminal t3.

Thereafter, the processing returns to 052, and in 053 the terminal t5 is selected. On the right side of the terminal t5 is the group G2 that is adjacent to the terminal t5 (the group on the left side is further away than the group G2). Therefore, the determination unit 312 calculates a difference between the nearest reproduction position in the group G2 (reproduction position of the terminal t6) and the reproduction position of the terminal t5 (053). It is assumed that in this case the difference exceeds the threshold value Δ1 (054), but is less than or equal to the threshold value Δ2 (057) (the reproduction position is somewhat near to the group G2). In this case, in 056, the reproduction speed of the terminal t5 is reduced by 0.02. Thereby, the reproduction position of the terminal t5 approaches the reproduction position of the terminal t6. Although the terminal t5 is not added to the group G2, because the reproduction position of the terminal t5 is brought near to the group G2 in 056, there is the possibility that the reproduction position will approach the group G2 to an extent to which the terminal t5 will eventually be added to the group G2.

Commands are handled in the manner described hereunder. When a command is to be assigned to a terminal in 041, 042 or the like, the command is issued at the gateway 3 (the content server 1 may also be caused to issue the command), and is transmitted to the terminal 5 that is the destination together with a fragment. However, a command may also be transmitted to the terminal 5 separately from a fragment.

As illustrated in FIG. 12, in the second embodiment, the proxy 6 of the terminal 5 includes the reproduction speed control unit 515. The content receiving unit 504 of the terminal 5 receives a command to change the reproduction speed from the gateway 3 together with a content fragment. The content receiving unit 504 passes the reproduction speed change command to the reproduction speed control unit 515, calls the API of the moving image reproduction application 7, and changes the reproduction speed of the moving image content.

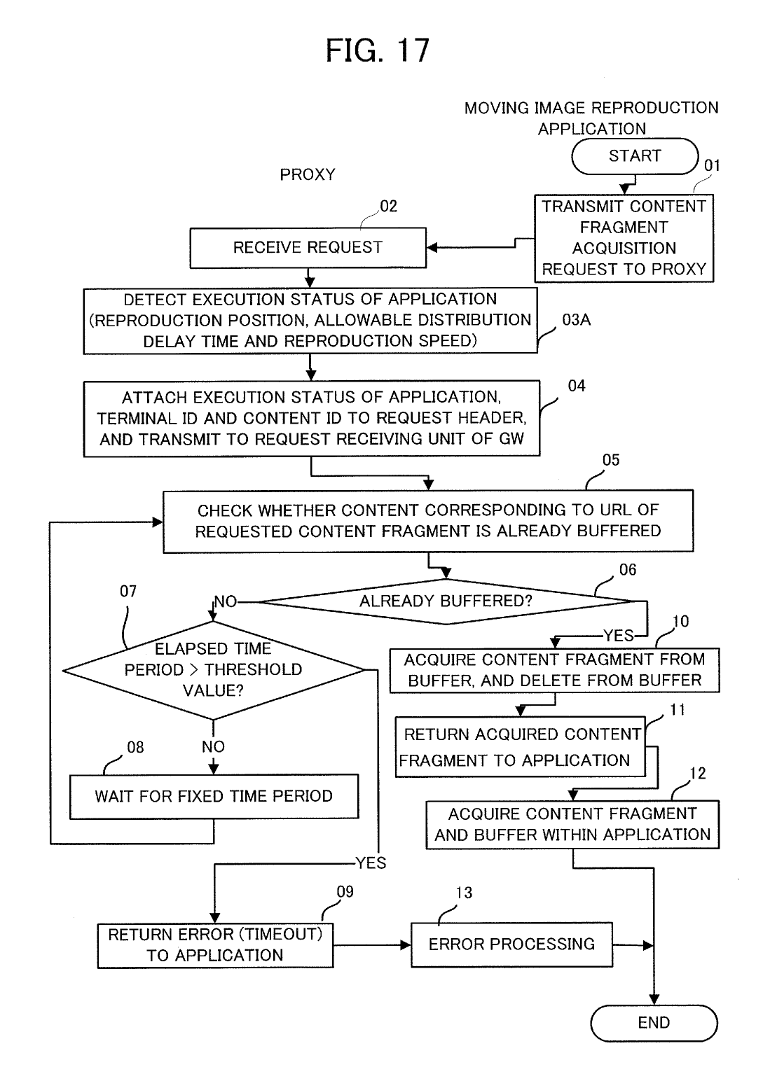

FIG. 17 is a flowchart illustrating an example of “processing 1” in the second embodiment. The “processing 1” in the second embodiment differs from the “processing 1” in the first embodiment in the respect that processing in 03A is performed instead of the processing in 03 (FIG. 7).

In the proxy 6, upon the request receiving unit 501 receiving a request from the application 7 (02), the execution status (reproduction position, allowable distribution delay time and reproduction speed) of the application 7 is detected using the application execution status detection unit 502 (03A). Since the processing in FIG. 17 is the same as the processing (FIG. 7) of the first embodiment except for the processing in 03A, a description thereof is omitted here.

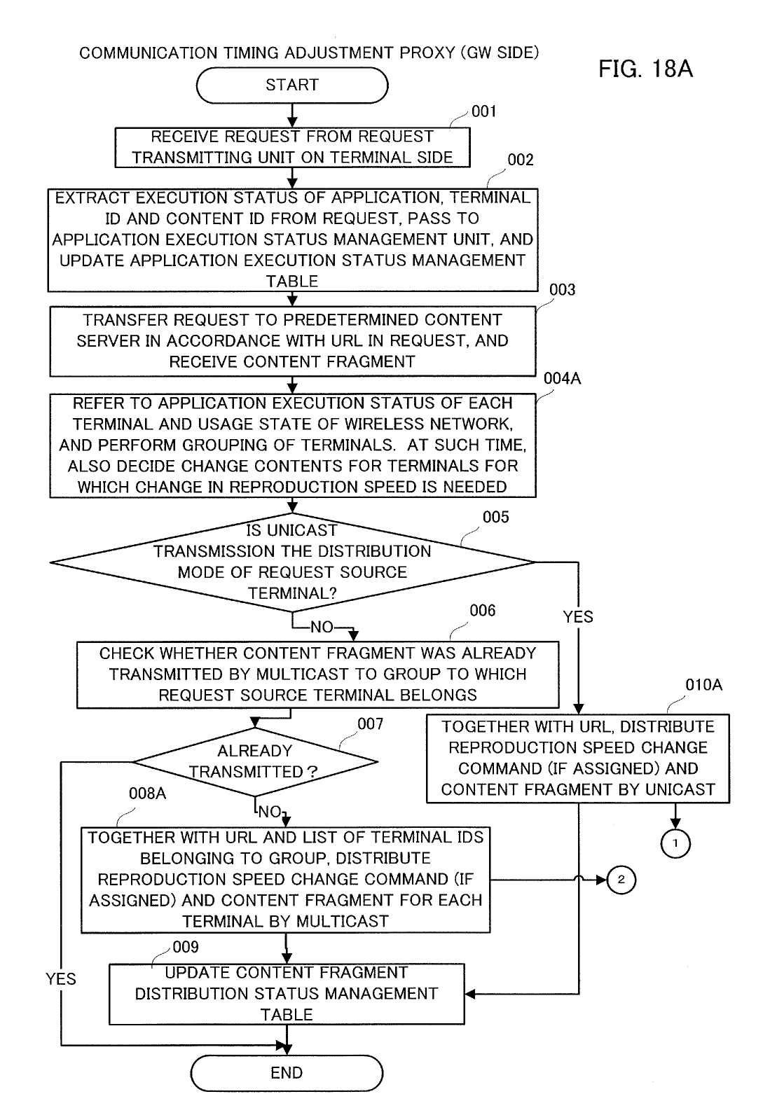

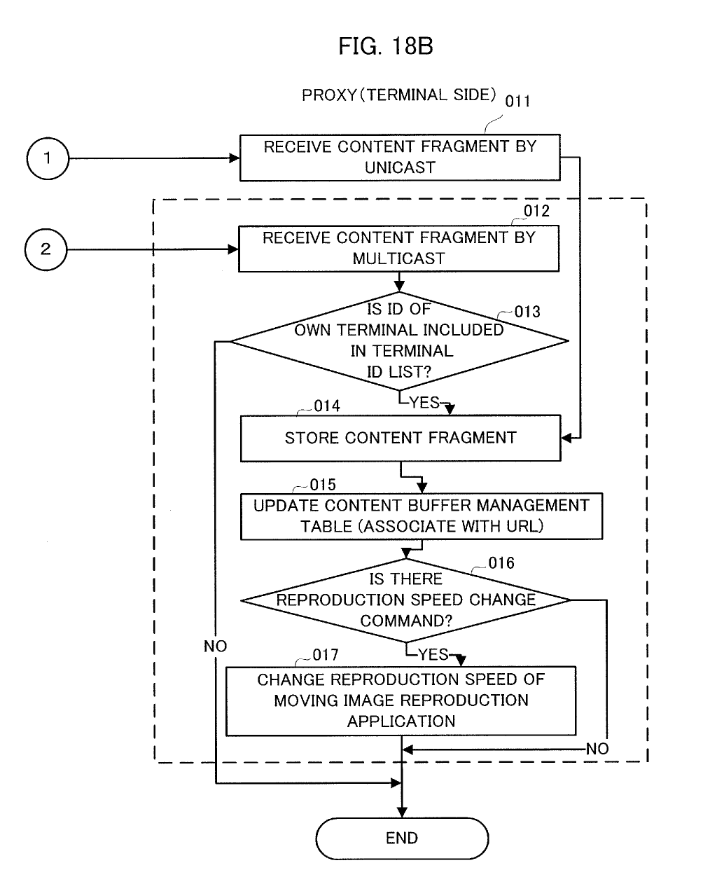

FIG. 18A and FIG. 18B are flowcharts that illustrate “processing 2” in the second embodiment. In FIG. 18A, the processing differs from the first embodiment in the respect that 004A, 008A and 010A are provided instead of 004, 008 and 010 in the processing (FIG. 8A and FIG. 8B) of the first embodiment. Further, as illustrated in FIG. 18B, the processing of the second embodiment differs from the first embodiment in the respect that 016 and 017 are added in the processing of the second embodiment.

In 004A, the terminal group determination unit 312 refers to the application execution status of each terminal 5 and the usage status of the wireless network 4, and performs grouping of terminals. At this time, the determination unit 312 determines (decides) the change contents for a terminal 5 for which a reproduction speed change is needed.

In 008A, the content distribution unit 314 distributes a fragment by multicast, together with a URL and a list of terminal IDs that belong to the group. At this time, when there is a change command for changing a reproduction speed, the change command is distributed together with the fragment.

In 010A, the content distribution unit 314 distributes a fragment by unicast together with the URL and the list of terminal IDs that belong to the group. At this time, when there is a change command for changing a reproduction speed, the change command is distributed together with the URL, the terminal ID list and the fragment.

In 016, whether or not there is a change command for changing the reproduction speed is determined, and when there is a change command, the reproduction speed of the content is changed by the moving image reproduction application 7 in accordance with the change command (017).

In the second embodiment, a difference between the reproduction speed of content at a second distribution destination that does not belong to a group and a reproduction speed at a first distribution destination that belongs to a group is determined. For instance, in the example illustrated in FIG. 16, the terminal t4 and the terminal t5 are second distribution destinations. The terminal t3 is a first distribution destination with respect to the terminal t4, and the terminal t6 is a first distribution destination with respect to the terminal t5. The terminal t3 belongs to the group G1 and the reproduction position thereof is located nearest to the reproduction position of the terminal t4. The terminal t6 belongs to the group G2 and the reproduction position thereof is located nearest to the reproduction position of the terminal t5.

The determination unit 312 is an example of a setting unit (056 in FIG. 15B) that sets a change in the reproduction speed that brings the reproduction position of the second distribution destination (t4 or t5) near to the reproduction position of the first distribution destination (t3 or t6) that belongs to a group (G1 or G2), based on a difference between the reproduction positions of the first and second distribution destinations.

In the second embodiment, furthermore, in a case where the difference between the reproduction position of the first distribution destination (t3) and the reproduction position of the second distribution destination (t4) is less than the threshold value Δ1, the determination unit 312 as a grouping unit adds the second distribution destination (t4) to the group G1 to which the first distribution destination (t3) belongs. As a result, the terminal t4 is included in a multicast group and a bandwidth reduction can be achieved.

In other words, in the second embodiment, the reproduction speed of content can be changed, and the number of terminals 5 belonging to a group can be increased. As a result, the occurrence of congestion can be suppressed more than in the first embodiment, and the possibility of the QoE of a user decreasing can be suppressed. The configurations of the above described embodiments can be combined as appropriate.

According to the above-described embodiments, it is possible to provide an apparatus and a method for allocating time slots to increase the number of communication apparatuses connected.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A content distribution control apparatus, comprising:
a grouping unit configured to perform grouping of a plurality of distribution destinations of content that is reproducible at different reproduction positions, based on a reproduction position of the content and information indicating a predetermined time period from the reproduction position that is obtained from each of the plurality of distribution destinations; and
a determination unit configured to determine, based on a usage status of a network that is used to distribute the content to the plurality of distribution destinations, a distribution method for distributing content to a group that is formed by the grouping.

2. The content distribution control apparatus according to claim 1, wherein:
from among the plurality of distribution destinations, the grouping unit is configured to group, into a single group, a first distribution destination and a distribution destination which is other than the first distribution destination and for which a reproduction position lies inside the predetermined time period that corresponds to the first distribution destination; and
the determination unit is configured to determine whether or not multicast distribution of the content to the single group is possible based on the usage status.

3. The content distribution control apparatus according to claim 1, wherein the determination unit is configured to prioritize performance of a determination regarding a distribution method for a group for which an amount of bandwidth reduction obtained by multicast distribution is largest in a case where a plurality of groups are formed by the grouping unit.

4. The content distribution control apparatus according to claim 1, further comprising:
a setting unit configured to set, based on a reproduction speed of the content at a second distribution destination that does not belong to the group and a difference between a reproduction position of a first distribution destination which belongs to the group and whose reproduction position is nearest to a reproduction position of the second distribution destination and the reproduction position of the second distribution destination, a change in a reproduction speed that brings the reproduction position of the second distribution destination near to a reproduction position of a distribution destination that belongs to the group.

5. The content distribution control apparatus according to claim 4, wherein the grouping unit is configured to add the second distribution destination to the group in a case where a difference between the reproduction position of the first distribution destination and the reproduction position of the second distribution destination is less than a threshold value.

6. A content distribution control method for controlling distribution to a plurality of distribution destinations of content that is reproducible at different reproduction positions, the method comprising:
grouping, using a processor, the plurality of distribution destinations based on a reproduction position of the content and information indicating a predetermined time period from the reproduction position that is obtained from each of the plurality of distribution destinations; and
determining, using the processor, a distribution method for distributing content to a group that is formed by the grouping, based on a usage status of a network that is used to distribute the content to the plurality of distribution destinations.

7. A non-transitory computer-readable recording medium having stored therein a program for causing a computer to execute a process for controlling distribution to a plurality of distribution destinations of content that is reproducible at different reproduction positions, the process comprising:
performing grouping of the plurality of distribution destinations based on a reproduction position of the content and information indicating a predetermined time period from the reproduction position that is obtained from each of the plurality of distribution destinations; and
determining a distribution method of content with respect to a group that is formed by the grouping, based on a usage status of a network that is used to distribute the content to the plurality of distribution destinations.
